(19) United States
(12) Patent Application Publication
(10) Pub. No.: US 2018/0179985 A1
(43) Pub. Date: Jun. 28, 2018

(54) RECIPROCATING INTERNAL COMBUSTION ENGINE, AND METHOD FOR PRODUCING A RECIPROCATING INTERNAL COMBUSTION ENGINE

(71) Applicant: NEUE HALBERG-GUSS GmbH, Saarbruecken (DE)

(72) Inventor: Christian REBMANN, Gersheim (DE)

(73) Assignee: NEUE HALBERG-GUSS GmbH, Saarbruecken (DE)

(21) Appl. No.: 15/737,401

(22) PCT Filed: Jun. 20, 2016
(86) PCT No.: PCT/DE2016/100279

§ 371 Date: Dec. 18, 2017

(30) Foreign Application Priority Data
Jun. 19, 2015 (DE) 10 2015 109 867.9

(51) Int. Cl. F02F 1/10; F02F 7/00; F02F 1/24

(52) U.S. Cl. CPC F02F 1/102; F02F 7/0002; B22D 19/0009; F02F 7/0085; F02F 1/24; F02F 7/0021

(57) ABSTRACT

An assembly, a crankcase, a reciprocating internal combustion engine, and a method for producing a reciprocating internal combustion engine facilitates engine block cleaning after casting, enables current and future residual-soiling standards to be met, and provides a solution to the challenges facing current and future high-performance engines, in particular the load zones head plate and cylinder tube, as well as potential for local improvement to properties in the crankcase in the additional load zones, namely the screw connection connecting the cylinder head and the crankshaft bearing. The assembly includes at least two cylinders and a platelike deck plate connecting them of integral design, wherein the platelike deck plate has a clearance for each cylinder and wherein the assembly can be inserted into or placed upon a crankcase of a reciprocating internal combustion engine, in that at least one coolant guideway is arranged between the cylinders.

### CROSS REFERENCE TO RELATED APPLICATIONS

This application is the National Stage of PCT/DE2016/100279 filed on Jun. 20, 2016, which claims priority under 35 U.S.C. § 119 of German Application No. 10 2015 109 867.9 filed on Jun. 19, 2015, the disclosure of which is incorporated by reference. The international application under PCT article 21(2) was not published in English.

### BACKGROUND OF THE INVENTION

### Field of the Invention

The present invention relates to a reciprocating internal combustion engine, and a method for producing a reciprocating internal combustion engine.

### Description of the Related Art

The production of castings is characterized by increasing integration of the casting's functional elements. This applies particularly to engine blocks, in particular cylinder crankcases. Crankcases of this kind have complex interior spaces which require complicated cleaning during the finishing process in order to remove sand residues and/or coating residues from the casting process. Cylinder crankcases, in particular, have a large number of integrated cast interior functions nowadays, such as water jackets, passages and channels for water or oil, which have to be cleaned after casting. A further difficulty is that the requirements concerning engine-component cleanliness and residual soiling have become much stricter of late.

At present, cleaning is performed with airless shot-blasting machinery, which essentially frees the outside of the component from casting-process residues. Interior surfaces are generally cleaned with a shot-blasting gun, with the manual process and model-related special-purpose guns dominating on account of the complexity of the interior spaces.

A current drawback is that this cleaning is laborious and is complicated by the large number of integrated cast internal functions, such as water jackets, passages and channels for water and oil.

Reciprocating internal combustion engines comprising a cylinder head, a crankcase and an assembly, wherein the outer wall areas of the assembly's cylinders and the wall areas of the crankcase's recess for accommodating the assembly form a coolant chamber, are known, for example, from U.S. Pat. No. 3,168,081 A and US 2006/037566 A1.

In addition to stricter requirements concerning the cleanliness of components and residual-soiling, the performance requirements for engine blocks, such as higher ignition pressures or higher temperature loads, have also increased. On account of the increasing performance requirements made on internal combustion engines, the four traditional load zones of a cylinder crankcase, namely bearing block, head screw connection, cylinder tube and inter-cylinder bridging area have reached the limit of what is currently technically feasible.

### SUMMARY OF THE INVENTION

Therefore, the problem addressed by this invention is that of facilitating engine block cleaning after casting, enabling current and future residual-soiling standards to be met, and providing a solution to the challenges facing current and future high-performance engines, in particular the load zones head plate and cylinder tube, as well as potential for local improvement to properties in the crankcase in the additional load zones, namely the screw connection connecting the cylinder head and the crankshaft bearing.

The problem is solved by a reciprocating internal combustion engine comprising a cylinder head, a crankcase and an assembly, wherein the crankcase comprises a recess for accommodating the assembly, wherein the assembly comprises at least two cylinders and the platelike deck plate connecting them, wherein the assembly is formed integrally, wherein the platelike deck plate has a clearance for each cylinder, and wherein the assembly can be inserted into a crankcase of a reciprocating internal combustion engine or placed upon a crankcase of a reciprocating internal combustion engine and wherein the assembly is arranged between the cylinder head and the crankcase and in the recess for accommodating the assembly and wherein the outer wall areas of the assembly's cylinders and the wall areas of the crankcase's recess for accommodating the assembly form a coolant chamber, in that at least one coolant guideway is arranged between the cylinders of the assembly, the coolant guideway for the assembly being realized by drilling through the area between two neighboring cylinders and/or by a coolant-guideway core in the area between two cylinders, and the assembly's platelike deck plate being configured free of openings except for the clearance for each of the cylinders.

It is within the scope of the invention for an assembly to be arranged between the cylinder head and the crankcase, wherein the assembly is of integral design and is inserted into a crankcase of a reciprocating internal combustion engine or is inserted with the platelike deck plate resting on the crankcase and with the cylinders extending into the recess of the crankcase for accommodating the cylinders of the assembly, and wherein the platelike deck plate serves to support the cylinder head and has a clearance for each cylinder.

Provision is made for the assembly of the reciprocating internal combustion engine to have a coolant guideway between the cylinders, this coolant guideway being realized by drilling through the area between two neighboring, possibly interconnected cylinders, and/or by means of a cooling-channel core in the area between two neighboring, possibly interconnected cylinders.

In the case of the reciprocating internal combustion engine according to the invention, provision is made for the outer wall areas of the assembly's cylinders and the wall areas of the crankcase's recess for accommodating the assembly to form a coolant/water chamber.

This embodiment has the advantage that, to form the coolant/water chamber, no draft angles or, in the case of pressure die casting, no removable cores or/and slides with a largish (1 to >2°) die cone are required. Parallel or stepped cylinder walls can be produced readily. On account of the selected die parting line, conducting/cooling/support ribs etc. may be provided on the cylinder tube, thereby making a cylinder wall suited to the requirements possible. The coolant chamber may accordingly be freely configured.

On account of the coolant chamber being formed by the separately produced components, namely assembly and crankcase, it is possible to produce a very thin or narrow water-jacket geometry. A significantly more filigree geometry is obtainable than is currently technically possible by means of cores and core slides.

The invention provides for the water-jacket geometry to have a thickness of less than 5 mm, preferably less than 3.5 mm.

The thin and/or narrow water-jacket geometry has the advantage that less coolant is required than with the known prior art. Accordingly, less pumping power is required than with known pumps and the pump may be configured smaller than the pumps used so far. This saves weight, and therefore cost, and also space.

In the case of the reciprocating internal combustion engine according to the invention, provision is furthermore made advantageously for the platelike deck plate connecting the at least two cylinders to be placed upon the crankcase or inserted into the recess for accommodating the assembly. “Placed upon” in this context means that the deck plate covers or overlaps the recess in the crankcase. “Inserted into” in this context means that the deck plate can be introduced into the recess in the crankcase in form-locking manner. In the case of the latter embodiment, the recess in the crankcase may have at least one inwardly directed, at least partially circumferential projection or seat, enabling the outer area of the deck plate to rest on the projection or seat.

Provision is made for the geometry of the recess in the crankcase for accommodating the assembly to be configured in such a way that at least part of the assembly, at least the cylinders, can be arranged in the crankcase.

Provision may advantageously be made for the internal geometry of the recess for accommodating the assembly to match the external geometry of the at least two cylinders, thereby allowing the cylinders to be inserted snugly into the crankcase. Additionally or alternatively, provision may be made for the upper, internal geometry of the recess for accommodating the assembly to match the external geometry of the deck plate, provision possibly being made for the deck plate to be held by a circumferential projection in the recess.

Separate production of the assembly and the “open” crankcase results in further advantages concerning production of the crankcase. For example, accessibility to component-internal feed measures is clearly facilitated, allowing the mechanical properties of the microstructure in the bearing block area to be positively influenced through use of cooling elements. An additional advantage is that cleaning of the “open” crankcase is facilitated, making it considerably easier to comply with residual-soiling standards.

A further advantage is that the crankcase of the invention may be produced according to requirements with favorably priced and easy-to-handle alloys. If sliding-surface coatings are used, masking measures to avoid overspray and additional, post-spraying cleaning steps in the crankcase are unnecessary.

The integral configuration of the multi-cylinder assembly advantageously enables the assembly to be produced as a separate component. Various methods may be used for the production thereof. The component is preferably produced by casting. However, the scope of the invention also provides for production of the assembly by means of a deep drawing process or by forging, using, for example, aluminum-copper wrought alloys.

According to the invention, the geometry of the platelike deck plate of the multi-cylinder assembly is freely configurable. For example, the thickness of the platelike deck plate may be selected to suit the loads incurred. It is furthermore conceivable in this context for the platelike deck plate to be thicker in loaded areas and of minimal thickness in non-loaded areas. Provision is also made for the geometry of the platelike deck plate to be freely configurable, for example in such manner that the platelike deck plate is adapted to the geometry of the crankcase and of the cylinder head.

Since the assembly need not include an integrated coolant chamber, the outer cylinder walls may be configured to suit the requirements. For example, a power-flow- and/or requirements-optimized support structure, such as reinforcement ribs and the like, or coolant ribs, may be realized on the outer walls. In this context, provision is advantageously made for the support structure (ribs) to be arranged on the cylinder walls in such a way as to optimize the flow. The support structure (ribs) is produced together with the cylinder.

According to the invention, at least one coolant guideway and/or bridging-area cooling means is arranged between the cylinders.

Since the assembly, with its cylinder geometries and the platelike deck plate, is not produced together with the cylinder crankcase, but is produced separately and is insertable therein or placeable thereon (the platelike deck plate rests on top of the crankcase while the cylinders extend into the crankcase), the coolant guideway may be of extremely all-purpose or extremely individual configuration, and is not restricted with regard to its position, e.g. also directly beneath and parallel to the deck plate.

Between the cylinders means that between at least two neighboring cylinders there is at least one cut-out or recess, allowing coolant to pass from one side of the assembly, through the cut-out or recess, to the opposite side of the assembly. The cylinders are accordingly also cooled in the area between the cylinders. In this context, according to the invention, a coolant guideway may be arranged between all neighboring cylinders. Provision may also be made for the coolant guideway to be arranged only between some cylinders, e.g. in every second area between two neighboring cylinders.

Another advantage of the invention is that the cylinder tube shape and cylinder tube wall may be configured freely to suit the requirements. The configuration of the cylinder tube shape is important in order to counteract deformation by the screw connection. For example, the cylinder tube wall may be of convex (bulging outwards), concave (curving inwards), sinusoidal or stepped configuration, or it may be a mixture of the aforementioned shapes, or it may be provided with support structures, cooling ribs or the like. The configurable cylinder tube shape and cylinder tube wall have the advantage that the cylinder wall thickness may be increased in the area of high ignition pressures. The selected shape (convex, concave . . . ) has the additional advantage of enabling flow optimization. For example, a higher flow velocity may be achieved by way of a suitable configuration.

Since the assembly is produced separately, e.g. by casting, and is only thereafter inserted into or placed upon, i.e. mounted in, the separately produced crankcase, the crankcase can be produced in the form of an “open” crankcase and the cylinders can be processed to a small extent prior to their insertion, allowing a large degree of freedom in the design of the cylinder's outer wall.

This enables better accessibility for crankcase-internal feed measures, for example in the case of non-ferrous alloys or iron-based materials, as well as significantly improved cleaning possibilities, both for the assembly and the “open” crankcase, with known cleaning methods. The invention also meets the currently very popular demand for a completely separate coolant supply to cylinder head and crankcase, since no openings for the support of the otherwise customary water jacket are needed, nor is there a need for removable-core slides. A closed deck configuration is therefore possible. However, if required, the platelike deck plate may be provided with localized openings allowing a connection between the crankcase coolant/water chamber and the cylinder-head coolant/water chamber.

Since the assembly is inserted into an “open” crankcase of a reciprocating internal combustion engine, the invention advantageously provides for the platelike deck plate to be dimensioned in such a manner that it is introduced into the crankcase in a manner that is, to all intents and purposes, form-locking. This configuration simplifies crankcase/assembly sealing.

An embodiment of the invention provides for the outer wall of the cylinders to have at least one horizontal bead running at least part of the way around the cylinder. The bead is preferably configured as a sealing bead. The sealing bead is preferably arranged on the cylinder in such a way as to form a seal between a coolant/water chamber (formed by the outer walls of the cylinder and the upper, inner walls of the crankcase) and the lower crankcase.

By virtue of the advantages described, the assembly offers potential for improving internal combustion engines in respect of increased ignition pressures and higher temperature loads, now and in the future, in the head plate and inter-cylinder bridging areas and in the cylinder tube.

More particularly, the assembly according to the invention will enable the challenges relating to thermal-shock resistance, thermal load on the inter-cylinder bridging area (“gusset”), tribology, plate stiffness and plate strength, cylinder deformation and coatability of the sliding surfaces (in the case of Al alloys) to be met more easily.

The invention furthermore provides for the platelike deck plate to be configured free of openings except for the clearance for each cylinder.

The advantage achieved with this configuration is that the stiffness and structure of the deck plate are not weakened by openings. This also facilitates sealing off the cylinder head from the cylinder crankcase on account of the absence, or practical absence, of beads, stoppers etc. on insertion of a cylinder-head gasket on the deck plate. A further advantage obtained thanks to this embodiment is that the internal combustion engine may be exposed to higher pressures. The tendency for cracks to form in the deck plate, promoted by openings as the starting point, is reduced or prevented.

The invention furthermore provides advantageously for the assembly to be made of cast iron with lamellar graphite (GJL), cast iron with vermicular graphite (GJV), cast iron with spheroidal graphite (GJS) and/or steel and/or a combination of the aforementioned materials.

On account of the assembly being produced separately, from one of these iron-based materials or from a combination thereof, it is possible to simplify production, by casting, for example, of the internal combustion engine as a whole. The separate production process also makes it possible to control the grain fineness and degree of porelessness of the cylinder tube's microstructure without influencing the crankcase. For example, it is possible to realize a chill layer near to the sliding surface. It is also, or additionally, possible to realize a chill throughout the cylinder wall. This separate treatment of the assembly makes it possible to improve thermal conduction and thermal transfer/removal into the cooling circuit and to adjust the mechanical properties better (tensile strength Rₘ, offset yield strength R_{p0,2} and fracture strain A). It is also advantageous that through use of iron-based materials, subsequent cylinder-liner joining and separate sliding-surface coating are rendered unnecessary. The use of cast iron with spheroidal graphite, in particular, enables higher strength and greater elongation to be obtained.

In an alternative embodiment of the assembly according to the invention, provision is made for the assembly to be made of non-ferrous materials, in particular aluminum alloys, such as aluminum-magnesium alloys (AlMgxx), aluminum-silicon alloys (AlSixx) with copper (Cu) and/or magnesium (Mg) and/or aluminum wrought alloys.

The use of non-ferrous materials for production of the assembly enables it to be produced without feed measures. The fact that subsequent casting and joining of a cylinder lining is unnecessary is especially advantageous. It is particularly useful that only the assembly is made of non-ferrous materials, in particular aluminum alloys, and not the complete cylinder crankcase (assembly and “open” crankcase).

In the case of non-ferrous materials, in particular aluminum-based non-ferrous materials, it is possible, though use of cooling elements, to produce a coatable sliding surface in the cylinder tube (molds of steel, GJL, Ms . . . ) without influencing the crankcase.

It is also conceivable for the assembly to have a cooling groove arranged on the side of the deck plate facing the cylinder head, which serves to reduce the temperature in the inter-cylinder bridging area. The invention furthermore provides for the cooling groove on the cylinder-head side to be supplied with coolant.

A reciprocating internal combustion engine comprising a cylinder head, a crankcase and an integral assembly consisting of a cylinder and a deck plate, wherein the platelike deck plate has a recess for the one cylinder and wherein the crankcase has a recess for accommodating the one integral assembly, consisting of a cylinder and a deck plate, is also described, in the case of which a portion of the assembly's cylinder wall and the recess in the crankcase for accommodating the assembly form a coolant/water chamber.

The assembly described here consists of exactly one cylinder and a deck plate. The deck plate may be configured according to the multi-cylinder assembly. Provision is also made for the single-cylinder assembly to be produced from the same materials as the multi-cylinder assembly.

The problem is also solved by a method for producing the reciprocating internal combustion engine.

The method comprises the following steps:
Separate production of the crankcase, the assembly and the cylinder head;
Insertion of the assembly into the crankcase;
Arrangement of the cylinder head on the platelike deck plate of the assembly;
Joining of the crankcase, the assembly and the cylinder head.

It is within the scope of the invention that the steps
Insertion of the assembly into the crankcase and
Arrangement of the cylinder head on the platelike deck plate of the assembly may be exchanged. The cylinder head may accordingly first be arranged on the platelike deck plate of the assembly, and may also be fastened thereon, after which the assembly with the cylinder head is inserted into the crankcase.

It is within the scope of the invention that joining of the crankcase, the assembly and the cylinder head is effected by means of customary methods such as screw connections, bonding, clamping, sealing or the like. The integral configuration of the assembly has the advantage that the cylinders are hardly or not at all deformed during the joining process because the power flow on joining (for example by tightening cylinder-head bolts) is decoupled from the cylinder tubes. A further advantage is that thinner walls are possible, leading to a reduction in weight and therefore also in cost.

### BRIEF DESCRIPTION OF THE DRAWINGS

The invention is explained below in more detail by reference to drawings, to which, however, it is not limited. The drawing in

FIG. 1 shows a perspective view of the assembly according to the invention, consisting of four cylinders and a platelike deck plate connecting them.

FIG. 2 shows a perspective view, turned over compared to FIG. 1, of the assembly, consisting of four cylinders and a platelike deck plate connecting them.

FIG. 3a shows a vertical side view of the assembly, consisting of four cylinders and a platelike deck plate connecting them, wherein the coolant guideway has been realized by drilling through the area between two longitudinally interconnected neighboring cylinders.

FIG. 3b shows a vertical side view of the assembly, consisting of four cylinders and a platelike deck plate connecting them, wherein the coolant guideway has been realized by a cooling-channel core in the area between two longitudinally interconnected neighboring cylinders.

FIG. 3c shows a vertical side view of the assembly, consisting of four cylinders and a platelike deck plate connecting them, wherein the coolant guideway has been realized by stand-alone cylinders.

FIG. 3d shows a vertical side view of the assembly, consisting of four cylinders and a platelike deck plate connecting them, wherein a coolant groove has been arranged on said platelike deck plate.

FIG. 4 shows an exploded view of a reciprocating internal combustion engine according to the invention, comprising a cylinder head and a crankcase; an assembly consisting of four cylinders and a platelike deck plate connecting these four cylinders is arranged between the cylinder head and the crankcase.

FIG. 5 shows an exploded view of an assembly according to the invention (VR-Inline variant) and a matching, open crankcase (VR-Inline crankcase); the assembly comprises six cylinders and a platelike deck plate connecting these cylinders, which are longitudinally offset relative to one another.

FIG. 6 shows an exploded view of a reciprocating internal combustion engine according to the invention and comprising a cylinder head and a crankcase; an assembly consisting of four cylinders and a platelike deck plate connecting these four cylinders has been arranged between the cylinder head and the crankcase. In the assembled state, the deck plate is supported on the crankcase.

FIG. 7 shows an exploded view of a reciprocating internal combustion engine according to the invention and comprising a cylinder head and a crankcase; an assembly consisting of four cylinders and a platelike deck plate connecting these four cylinders has been arranged between the cylinder head and the crankcase. In the assembled state, the deck plate is seated, in substantially form-locking manner, in the crankcase recess.

FIG. 8 shows a perspective view of the assembly, consisting of four cylinders and a platelike deck plate connecting them, wherein the assembly has four differently oriented cooling grooves on the cylinders.

FIGS. 9a-9f show various sectional views of an assembly arranged in an open crankcase.

FIGS. 10a-10f show various sectional views of an assembly arranged in an open crankcase.

### DETAILED DESCRIPTION OF PREFERRED EMBODIMENTS

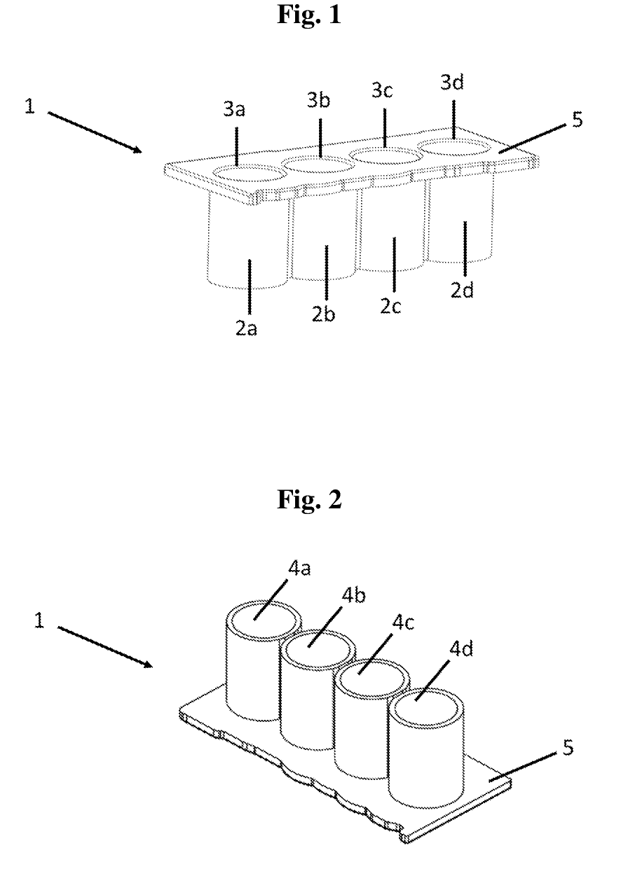

FIG. 1 shows a perspective view of an assembly (1), consisting of four cylinders (2a, 2b, 2c, 2d) and a platelike deck plate (5) connecting these cylinders; the assembly (1) consisting of at least two cylinders (2a, 2b, 2c, 2d) and the platelike deck plate (5) connecting these cylinders is configured as one piece. As shown, the platelike deck plate (5) has a clearance (3a; 3b; 3c; 3d) for each cylinder (2a; 2b; 2c; 2d). Provision is made for the assembly (1) to be insertable in, or placeable on, an (“open”) crankcase (7a; 7b) of a reciprocating internal combustion engine. The drawing also shows that, except for the recess (3a; 3b; 3c; 3d) for each cylinder (2a; 2b; 2c; 2d), the platelike deck plate (5) is configured free of openings.

FIG. 2 shows a perspective view, turned over compared to FIG. 1, of the assembly (1), consisting of four cylinders and a platelike deck plate (5) connecting them. Because the assembly (1) is produced separately, it is possible, though use of cooling elements, to produce a coatable sliding surface (4a; 4b; 4c; 4d) in the cylinder tube, (molds made of steel, GJL, Ms, . . . ), without influencing the crankcase. The separate production process also makes it possible to control the grain fineness and degree of porelessness of the cylinder tube's microstructure without influencing the crankcase. For example, it is possible to realize a chill layer near to the the sliding surface. It is also, or additionally, possible to realize a chill throughout the cylinder wall.

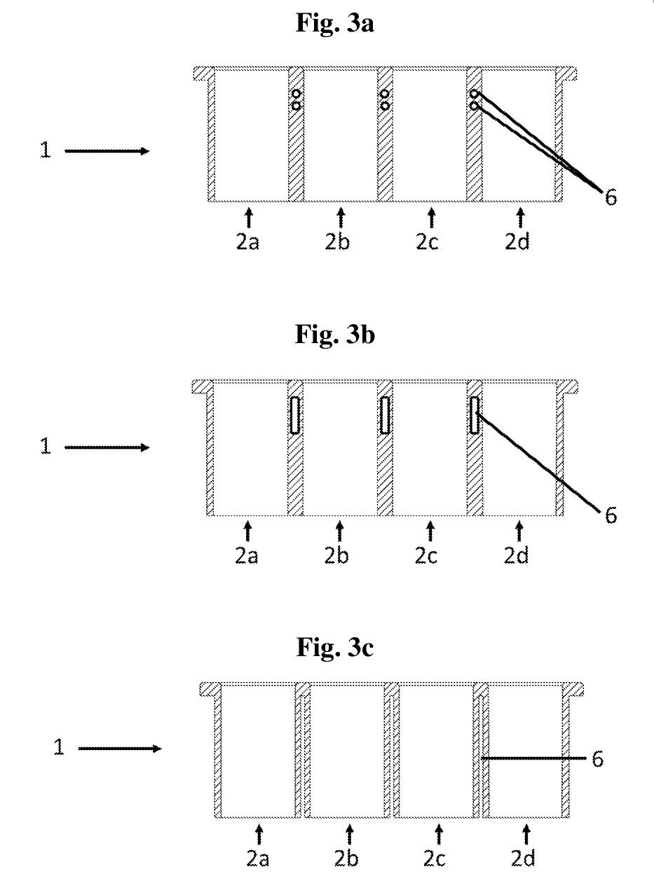

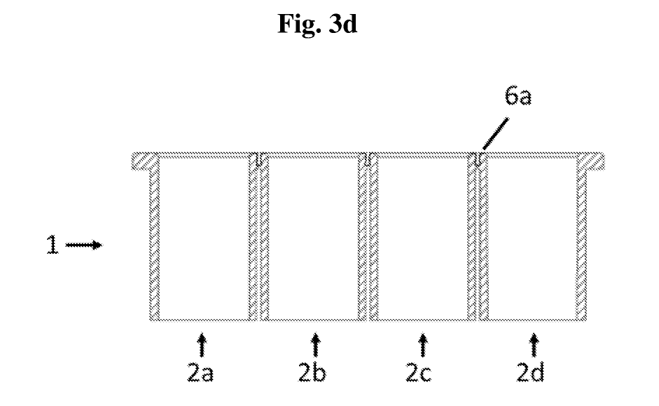

FIGS. 3a to 3c show vertical side views of the assembly (1), consisting of four cylinders (2a, 2b, 2c, 2d) and a platelike deck plate connecting them. FIG. 3a shows that the coolant guideway (6) may be realized by drilling through the area between two longitudinally interconnected neighboring cylinders. FIG. 3b shows that the coolant guideway (6) may be realized by a coolant-channel core in the area between two longitudinally interconnected neighboring cylinders (2a, 2b, 2c, 2d). FIG. 3c shows that that the coolant guideway (6) may be realized by stand-alone cylinders (2a; 2b; 2c; 2d).

FIG. 3d shows a vertical side view of the assembly (1), consisting of four cylinders (2a, 2b, 2c, 2d) and a platelike deck plate connecting them. FIG. 3d shows that a cooling groove (6a) is arranged in the platelike deck plate. The geometry, shape and position of the cooling groove (6a) are not limited to the slot-like configuration shown, but may be arranged on the deck plate according to need.

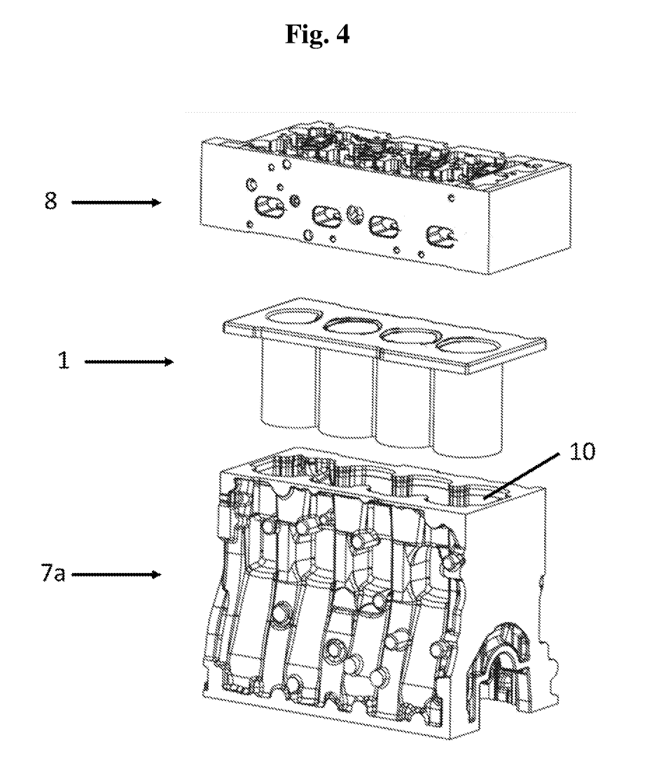

FIG. 4 shows an exploded view of a reciprocating internal combustion engine according to the invention, comprising a cylinder head (8) and a crankcase (7a) according to the invention; an assembly (1) consisting of four cylinders and a platelike deck plate connecting these four cylinders is arranged between the cylinder head (8) and the crankcase (7a).

As shown in FIG. 4, no separate cylinder-head gasket is required, thereby enabling direct, planar power transmission which is not limited to the cylinder-head gasket contour. This is to advantage, particularly in the high-load area (compression zone).

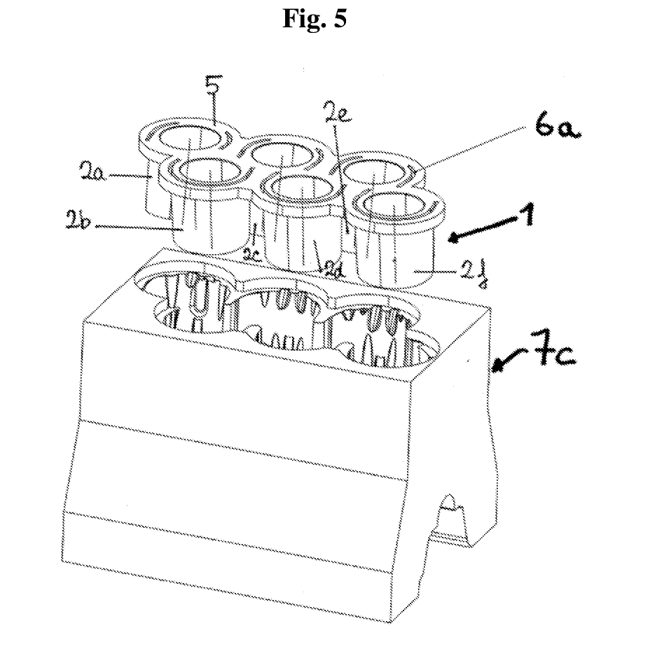

FIG. 5 shows an exploded view of an assembly (1; VR6-Inline variant) and a matching, open crankcase (7c; VR6-Inline crankcase). The assembly (1) comprises six cylinders (2, 2b, 2c, 2d, 2e, 2f) and a deck plate (5) connecting these cylinders. The assembly (1) is configured such that it is inserted into the crankcase (7c) (the platelike deck plate may rest, in substantially form-locking manner, on a seat in the crankcase; the cylinders are guided in the crankcase). The cylinders are longitudinally offset relative to one another, each being offset (relative to the longitudinal axis) by approx. 15%. The cylinders (2a, 2b, 2c, 2d, 2e, 2f) may be arranged such as to be guided freely in the crankcase (7c). The internal surface of the recess in the crankcase (for accommodating the assembly) may be essentially smooth or, as shown here, be profiled. Cooling grooves (6a) are shown on the platelike deck plate (5). The cooling grooves (6a) run radially for at least part of the way around the recesses for the cylinders, the shape, size, number, depth and position of the grooves being freely configurable.

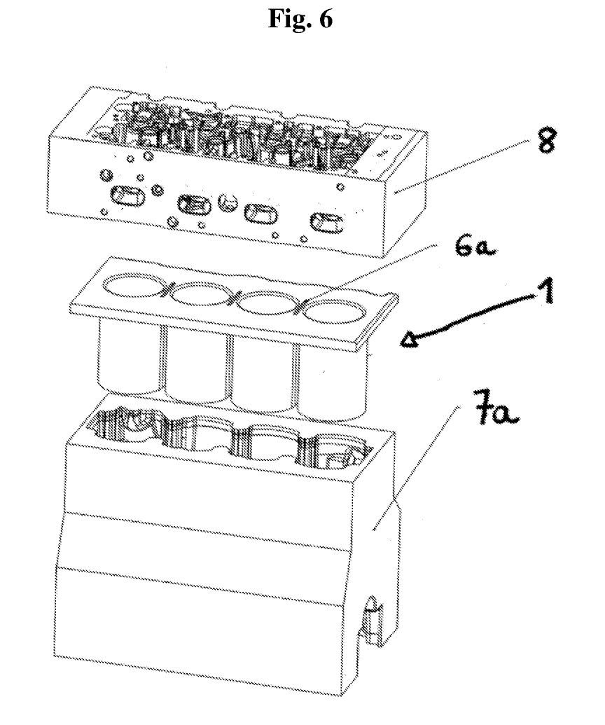

FIG. 6 shows an exploded view of a reciprocating internal combustion engine according to the invention. The reciprocating internal combustion engine comprises a cylinder head (8) and a crankcase (7a); an assembly (1) consisting of four cylinders and a platelike deck plate connecting these four cylinders is arranged between the cylinder head (8) and the crankcase (7a). In the reciprocating internal combustion engine according to the invention, the assembly (1) is placed upon the crankcase (7a) (the platelike deck plate rests on top of the crankcase: the cylinders are guided in the crankcase). Three cooling grooves (6a) are shown on the platelike deck plate. The cooling grooves (6a) are arranged between the clearances for the cylinders.

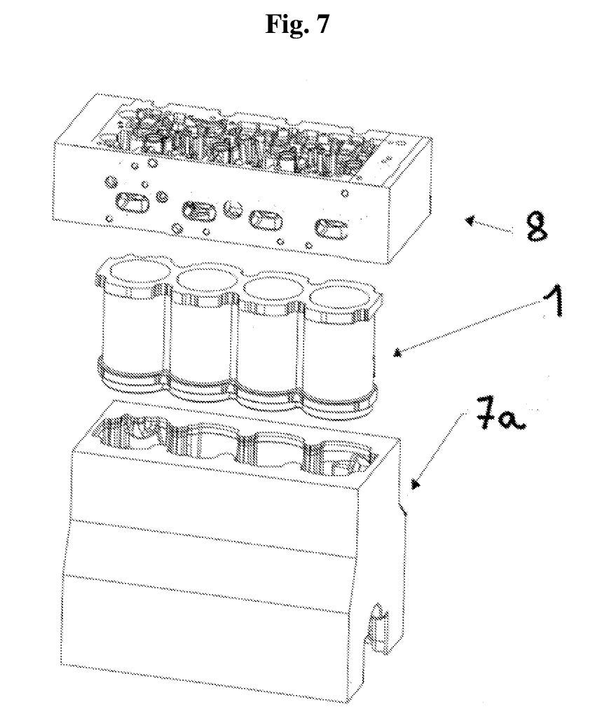

FIG. 7 shows an exploded view of a reciprocating internal combustion engine according to the invention. The reciprocating internal combustion engine comprises a cylinder head (8) and a crankcase (7a); an assembly (1) consisting of four cylinders and a platelike deck plate connecting these four cylinders is arranged between the cylinder head (8) and the crankcase (7a). In the reciprocating internal combustion engine according to the invention, the assembly (1) is inserted into the crankcase (7a) in form-locking manner (the platelike deck plate rests on a shoulder in the crankcase such that, in the assembled state, the deck plate and the top of the crankcase are planar; the cylinders are guided in the crankcase).

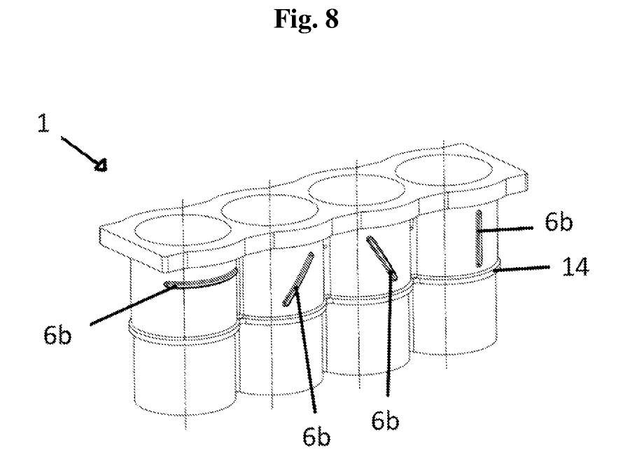

FIG. 8 shows a perspective view of an assembly (1) according to the invention, consisting of four cylinders and a deck plate connecting these cylinders, wherein the assembly (1) is integrally formed. The exterior walls of the cylinder have a horizontal, circumferential bead (14). The bead (14) is preferably configured as a sealing bead and, in the operational state (assembled state of the reciprocating internal combustion engine), serves as a seal between the coolant/water chamber (formed by the outer walls of the cylinders and the upper, inner walls of the crankcase) and the lower crankcase. The shape, position and size of the bead (14) are freely configurable. FIG. 8 also shows that support structures (6b) (four are shown), in this case reinforcement ribs, which may also be cooling ribs, are provided on the outer cylinder walls. The ribs have the effect, inter alia, of optimizing the flow. The support structures (ribs) may be arranged arbitrarily (as shown, e.g., longitudinally, transversely or obliquely) on the outer walls of the cylinders.

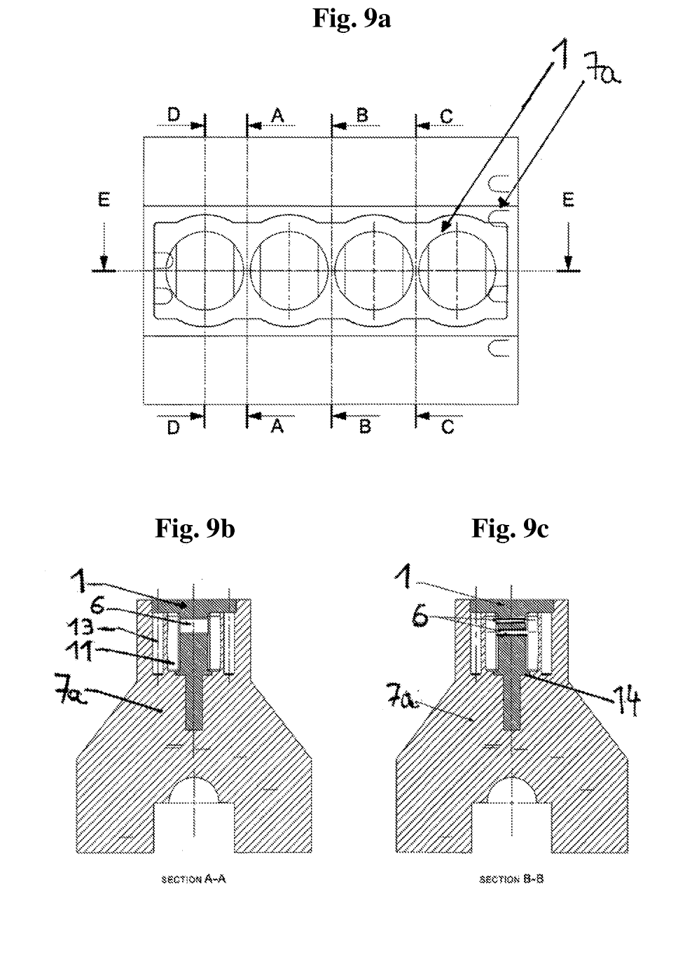

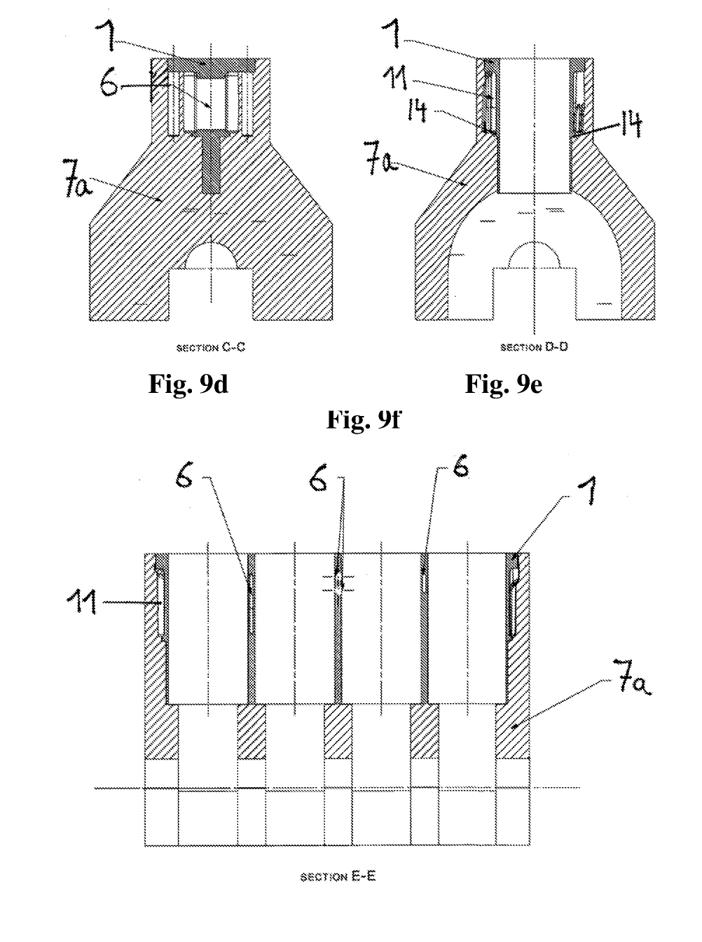

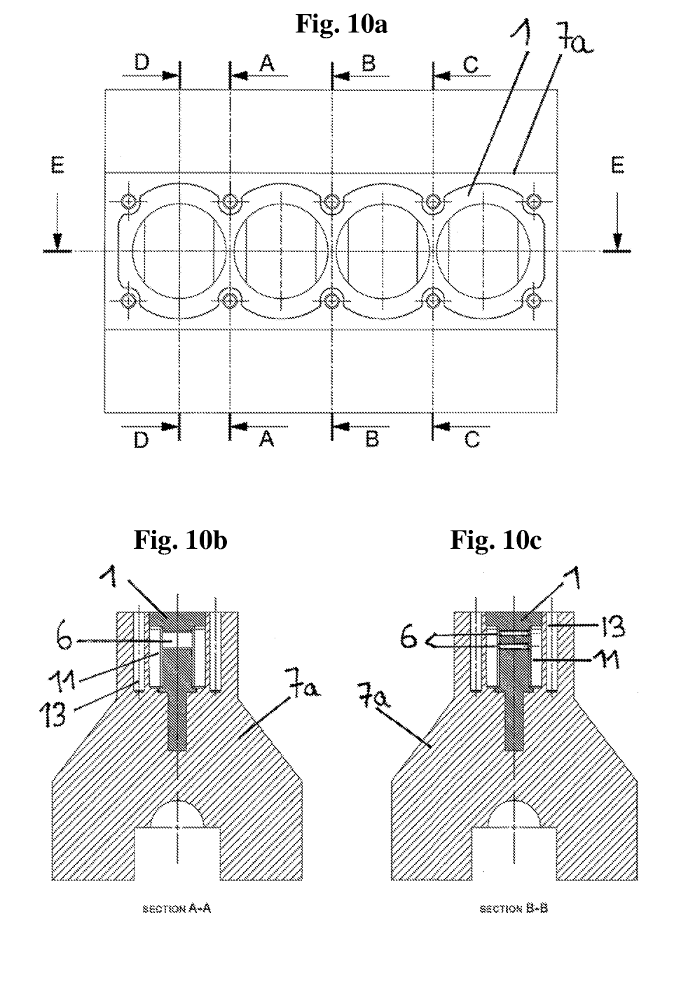

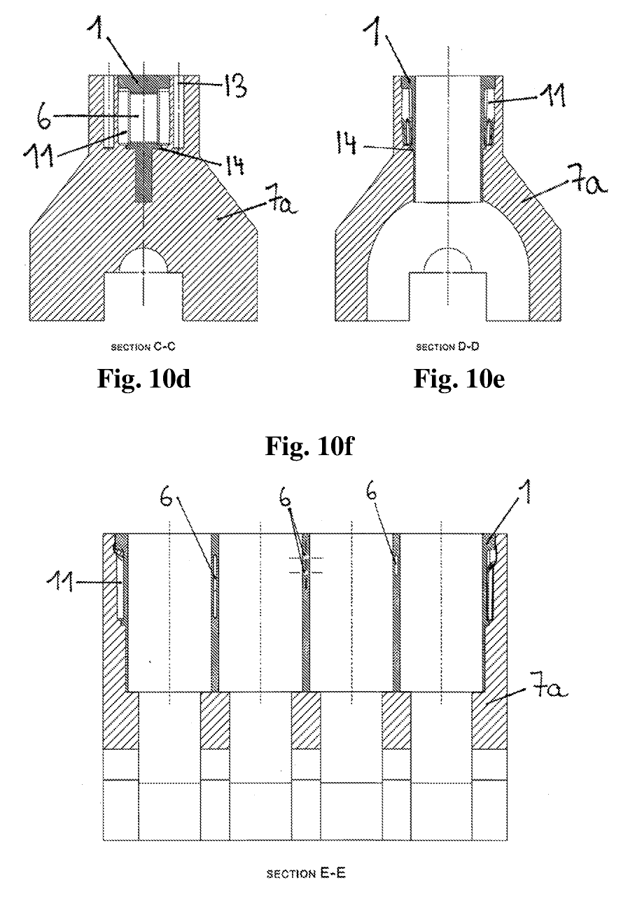

In FIGS. 9a to 9f, the assembly (1) is shown, in various sectional views and sectional planes, arranged as an assembly placed upon a crankcase (7a). FIG. 9a shows a top view of the assembly placed upon the crankcase and indicates the sectional planes for the FIGS. 9b to 9f. FIG. 9b shows the sectional plane A-A, FIG. 9c the sectional plane B-B, FIG. 9d the sectional plane C-C, FIG. 9e the sectional plane D-D and FIG. 9f the sectional plane E-E. In FIG. 9b, which shows the sectional plane A-A, the assembly (1) has been placed upon and connected to the crankcase (7a) by means of fastening means (13), here cylinder-head tension bolts. The tension bolts are screwed through the platelike deck plate of the assembly (1) into the crankcase. As shown, the coolant/water chamber (11) is formed by the outer walls of the cylinders and the upper, inner walls of the crankcase. FIGS. 9b to 9f also show that the outer wall of the cylinder depicted here has a horizontal, circumferential bead (14). The bead is configured as a sealing bead (cf. FIG. 10e). The sealing bead is arranged on the cylinder in such a way as to form a seal between the coolant/water chamber (11) and the lower crankcase. In this example, for purposes of better illustration, the assembly (1) has been provided with three different coolant guideways (6), although each of the variants can be implemented individually and in combination. FIG. 9b shows a slot-like coolant guideway, FIG. 9c shows two horizontally drilled coolant guideways and FIG. 9d shows a coolant guideway realized by way of stand-alone cylinders. In FIG. 9f, these coolant guideways are shown as section E-E from left to right. The coolant guideways (6) are connected to the coolant/water chamber (11), thereby allowing coolant to be guided, i.e. circulated around the cylinders.

In FIGS. 10a to 10f, the assembly (1) is shown, in various sectional views and sectional planes, arranged as an assembly inserted in a crankcase (7a). FIG. 10a shows a top view of the assembly inserted upon the crankcase and indicates the sectional planes for the FIGS. 10b to 10f. FIG. 10b shows the sectional plane A-A, FIG. 10c the sectional plane B-B, FIG. 10d the sectional plane C-C, FIG. 10e the sectional plane D-D and FIG. 10f the sectional plane E-E. FIGS. 10a to 10e show that the fastening means (13), here cylinder-head tension bolts, engage the crankcase (7a) but not the assembly (1). As shown, the coolant/water chamber (11) is formed by the outer walls of the cylinders and the upper, inner walls of the crankcase. FIGS. 10b to 10f also show that the outer wall of the cylinder depicted here has a horizontal, circumferential bead (14). The bead is configured as a sealing bead (see FIG. 10e). The sealing bead is arranged on the cylinder in such a way as to form a seal between the coolant/water chamber (11) and the lower crankcase. In this example, for purposes of better illustration, the assembly (1) has been provided with three different coolant guideways (6), although each of the variants can be implemented individually and in combination. FIG. 10b shows a slot-like coolant guideway, FIG. 10c shows two horizontally drilled coolant guideways and FIG. 10d shows a coolant guideway realized by way of stand-alone cylinders. In FIG. 10f, these coolant guideways are shown as section E-E from left to right. The coolant guideways (6) are connected to the coolant/water chamber (11), thereby allowing coolant to be guided, i.e. circulated around the cylinders.

1. Reciprocating internal combustion engine comprising a cylinder head (8), a crankcase (7a; 7b) according to claim 7 and an assembly (1),
wherein the crankcase (7a; 7b) comprises a recess (10) for accommodating the assembly (1),
wherein the assembly (1) comprises at least two cylinders (2a, 2b; 2a, 2b, 2c; 2a, 2b, 2c, 2d; 2a, 2b, 2c, 2d, 2e, 2f) and a platelike deck plate (5) connecting them,
wherein the assembly (1) is of integral design,
wherein the platelike deck plate (5) has a clearance (3a; 3b; 3c; 3d; 3e; 3f) for each cylinder (2a; 2b; 2c; 2d; 2e; 2f) and
wherein the assembly (1) can be inserted into a crankcase (7a; 7b; 7c) of a reciprocating internal combustion engine or placed upon a crankcase (7a; 7b; 7c) of a reciprocating internal combustion engine, and
wherein the assembly (1) is arranged between the cylinder head (8) and the crankcase (7a; 7b; 7c) and in the recess (10) for accommodating the assembly (1) and
wherein the outer wall areas of the cylinders (2a, 2b, 2c, 2d; 2a, 2b, 2c, 2d, 2e, 2f) of the assembly (1) and the wall areas of the recess (10) in the crankcase (7a; 7b; 7c) for accommodating the assembly (1) form a coolant chamber (11),
wherein at least one coolant guideway (6) is arranged between the cylinders (2a, 2b; 2b, 2c; 2c, 2d; 2e, 2f; 2a, 2b, 2c; 2c, 2d, 2e) of the assembly (1),
wherein the coolant guideway (6) of the assembly (1) is realized by drilling through the area between two neighboring cylinders (2a, 2b; 2b, 2c; 2c, 2d; 2d, 2e; 2e, 2f) and/or by a cooling-channel core in the area between two cylinders (2a, 2b; 2b, 2c; 2c, 2d; 2d, 2e; 2e, 2f), and the platelike deck plate (5) of the assembly (1) is configured free of openings except for the clearance (3a; 3b; 3c; 3d) for each cylinder (2a; 2b; 2c; 2d).

2-3. (canceled)

4. Reciprocating internal combustion engine according to claim 1, wherein the assembly (1) is made of cast iron with lamellar graphite (GJL), cast iron with vermicular graphite (GJV), cast iron with spheroidal graphite (GJS) and/or steel and/or a combination of the aforementioned materials.

5. Reciprocating internal combustion engine according to claim 1, wherein the assembly (1) is made of non-ferrous materials, in particular aluminum alloys, such as aluminum-magnesium alloys (AlMgxx), aluminum-silicon alloys (AlSixx) with copper (Cu) and/or magnesium (Mg) and/or aluminum wrought alloys.

6-9. (canceled)

10. Reciprocating internal combustion engine according to claim 1, wherein the platelike deck plate (5) connecting the at least two cylinders (2a, 2b; 2a, 2b, 2c; 2a, 2b, 2c, 2d; 2a, 2b, 2c, 2d, 2e, 2f) is placed upon the crankcase (7a, 7b; 7c) or inserted into the recess (10) for accommodating the assembly (1).

11. (canceled)

12. Method of producing the reciprocating internal combustion engine according to claim 1, comprising the following steps:
Separate production of the crankcase (7a; 7b; 7c), the assembly (1) and the cylinder head (8),
Insertion of the assembly (1) into the crankcase (7a; 7b; 7c),
Arrangement of the cylinder head (8) on the platelike deck plate (5) of the assembly (1),
Joining of the crankcase (7a; 7b; 7c), the assembly (1) and the cylinder head (8).

13. Method of producing the reciprocating internal combustion engine according to claim 1, comprising the following steps:
Separate production of the crankcase (7a; 7b; 7c), the assembly (1) and the cylinder head (8),
Arrangement of the cylinder head (8) on the platelike deck plate (5) of the assembly (1),
Insertion of the assembly (1) into the crankcase (7a; 7b; 7c),
Joining of the crankcase (7a; 7b; 7c), the assembly (1) and the cylinder head (8).
